(19) United States
(12) Patent Application Publication
(10) Pub. No.: US 2023/0318429 A1
(43) Pub. Date: Oct. 5, 2023

(54) POWER CONVERSION APPARATUS

(71) Applicant: DENSO WAVE INCORPORATED, Chita-gun (JP)

(72) Inventor: Youtarou MURAKAMI, Chita-gun (JP)

(73) Assignee: DENSO WAVE INCORPORATED, Chita-gun (JP)

(21) Appl. No.: 18/190,299

(22) Filed: Mar. 27, 2023

(30) Foreign Application Priority Data
Mar. 30, 2022 (JP) 2022-055169

(51) Int. Cl. H02M 1/00; H02J 7/35

(52) U.S. Cl. CPC H02M 1/0006; H02J 7/35

(57) ABSTRACT

Provided is a power conversion apparatus including: an isolated converter that is connected to the first converter, the second converter, and the rechargeable battery, and that is configured to bidirectionally convert voltage of direct-current power supplied from a connection destination; and a control unit that is configured to cause the isolated converter to vary voltage at a direct-current input-output terminal of the first converter in accordance with power generated by a photovoltaic power generator, the direct-current input-output terminal being connected to the isolated converter, wherein the first converter is configured to convert alternating-current power supplied from a grid power line to direct-current power, the second converter is configured to convert voltage of direct-current power supplied from the photovoltaic power generator, and to supply the voltage-converted direct-current power to the direct-current input-output terminal of the first converter.

### CROSS-REFERENCE TO RELATED APPLICATION

This application is based on and claims the benefit of priority from earlier Japanese Patent Application No. 2022-055169 filed Mar. 30, 2022, the description of which is incorporated herein by reference.

### BACKGROUND OF THE INVENTION

### Technical Field of the Invention

The present disclosure relates to a power conversion apparatus applied to a system including a photovoltaic power generator that generates power by using solar light.

### Related Art

Nowadays, along with promotion of carbon neutrality, there is a growing interest in increasing efficiency of power supply apparatuses. Especially, attention has been drawn to natural energy. More specifically, both commercial use and non-commercial use of photovoltaic power-generation systems have become widespread. With a domestic photovoltaic power-generation system to be linked to a grid power supply, in accordance with use of domestic power, power can be purchased, and power generated by using solar light can be sold. However, in the photovoltaic power-generation system, in order to prevent shock hazards in case where a power failure occurs in the grid power supply, operation of a power controller (in other words power conditioner) arranged in the photovoltaic power-generation system is stopped. Thus, there is a disadvantage that electricity is unavailable in case of disaster or the like.

In view of such circumstances, in order that power can be supplied even in case of disaster, V2H (Vehicle to Home) systems that utilize a domestic rechargeable battery and a high-capacity battery installed in an electric car or a hybrid electric car also have been proposed and put on sale. In the V2H systems, as shown in FIG. 6, a charger/discharger for the battery installed in the vehicle has a self-sustaining discharge function used only in case of a power failure. In case of a power failure, the V2H system disconnects, on its distribution board, power supply from the grid power supply to electrical appliances, and establishes connection to a self-sustaining discharge line that is connected to the charger/discharger. With this, AC (Alternating Current) power is supplied to the domestic electrical appliances.

Also in case of emergency, the power controller of the photovoltaic power-generation system detects an AC waveform (such as a sine wave) on the self-sustaining discharge line. As a result, the power controller falsely recognizes that the grid power supply is normal, and supplies the generated power to a load as in normality. In order that the power supply by the above-described photovoltaic power-generation system is continued, the charger/discharger for the vehicle needs to output an undistorted AC waveform as the grid power supply outputs. However, depending on compatibility with the power controller and on use of the electrical appliances, a distorted AC waveform is output. In response thereto, the operation of the power controller is stopped, and hence the photovoltaic power-generation system cannot supply the power.

In order to solve such problems, there is a technology as disclosed in Patent Literature 1 (JP 2019-193444 A), in which, in order that converters for a photovoltaic power-generation panel (that is, the power controller) and a charging/discharging converter for a battery (that is, the charger/discharger) cooperate with each other, the power controller and the charger/discharger are integrated with each other into a power conversion system. In other words, where to arrange the charger/discharger is changed from a vehicle to a house.

### SUMMARY

However, the technology disclosed in Patent Literature 1 may cause decrease in power conversion efficiency. For example, in the technology disclosed in Patent Literature 1, a DC (Direct Current) bus voltage in the power conversion system needs to be adjusted to a voltage of the power controller for the photovoltaic power-generation panels. However, in many cases, the voltage of the charger/discharger is lower than the voltage of the power controller. Thus, loss occurs in step-down conversion when charging the battery, resulting in decrease in power conversion efficiency.

The present disclosure has been made in view of the circumstances as described above, and an object thereof is to provide a power conversion apparatus in which a converter for a photovoltaic power generator and a charging/discharging converter for a battery are integrated with each other, and which is capable of suppressing decrease in power conversion efficiency.

According to an embodiment of the present disclosure, there is provided a power conversion apparatus including:
an isolated converter
   that is arranged between a rechargeable battery and a set of a first converter and a second converter,
   that is connected to the first converter, the second converter, and the rechargeable battery, and
   that is configured to bidirectionally convert voltage of direct-current power supplied from a connection destination; and
a control unit that is configured to cause the isolated converter to vary voltage at a direct-current input-output terminal of the first converter in accordance with power generated by a photovoltaic power generator, the direct-current input-output terminal being connected to the isolated converter, wherein
the first converter is configured to convert alternating-current power supplied from a grid power line to direct-current power,
the second converter is configured
   to convert voltage of direct-current power supplied from the photovoltaic power generator, and
   to supply the voltage-converted direct-current power to the direct-current input-output terminal of the first converter.

### BRIEF DESCRIPTION OF THE DRAWINGS

In the accompanying drawings:

FIG. 1 is a diagram showing a configuration of a power conversion system according to a first embodiment of the present disclosure;

FIG. 2 is a flowchart showing contents of processes by a control unit of a power conversion apparatus according to the first embodiment of the present disclosure;

FIG. 3 is a timing chart showing an example of how an amount of generated power varies over time, and how bus voltage and a switching frequency vary in accordance with the processes by the control unit according to the first embodiment of the present disclosure;

FIG. 4 is a diagram showing equivalent circuits that include resonant circuits and are arranged on both sides of a transformer of a power supply unit of the power conversion apparatus according to the first embodiment of the present disclosure;

FIG. 5 is a diagram showing a configuration of a power conversion system according to a second embodiment of the present disclosure;

FIG. 6 is a diagram showing a configuration of a general V2H system; and

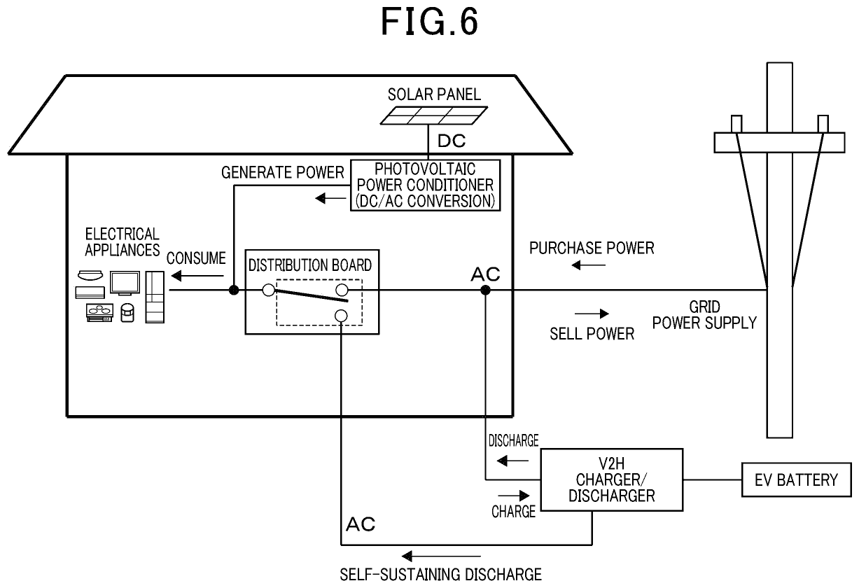

FIG. 7 is a diagram showing a hardware configuration of a control unit according to an embodiment of the present disclosure.

### DETAILED DESCRIPTION OF THE PREFERRED EMBODIMENTS

### First Embodiment

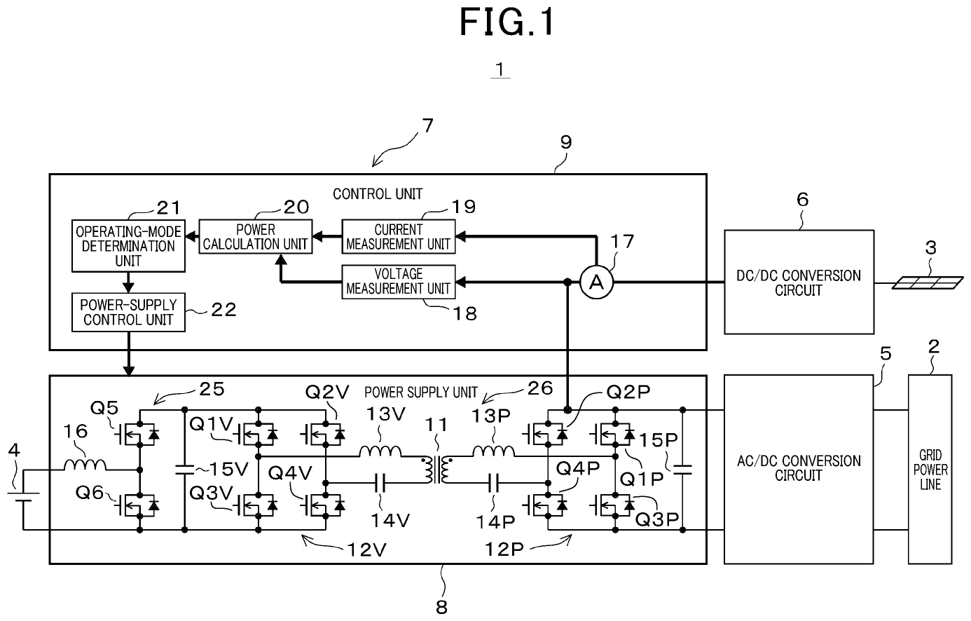

Now, a first embodiment of the present disclosure is described. FIG. 1 is a diagram showing a configuration of a V2H system 1 being a power conversion system according to this embodiment. The V2H system 1 is configured to convert and transmit power between a grid power line 2, a solar panel 3 being a photovoltaic power generator, and a rechargeable battery 4. Note that, the rechargeable battery 4 may be installed in electric cars so that drive power is supplied to their drive motors, and need not necessarily be installed in the electric cars.

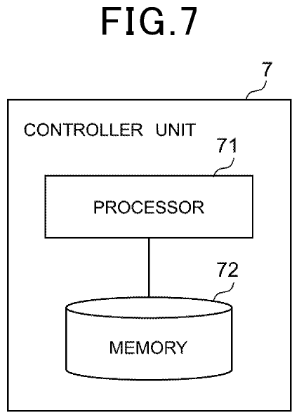

The V2H system 1 includes an AC (Alternating Current)/DC (Direct Current) conversion circuit 5 that is connected to the grid power line 2, a DC/DC conversion circuit 6 that is connected to the solar panel 3, and a power conversion apparatus 7. The power conversion apparatus 7 is arranged between the rechargeable battery 4 and a set of the AC/DC conversion circuit 5 (a first converter) and the DC/DC conversion circuit 6 (a second converter). The power conversion apparatus 7 includes a power supply unit 8 and a control unit 9. As shown in FIG. 7, the control unit 9 includes a processor 71 such as a CPU (Central Processing Unit) and a memory 72 such as a ROM (Read Only Memory) or a RAM (Random Access Memory). The power supply unit 8 is a resonant isolated converter. In the power supply unit 8, full-bridge circuits 12V and 12P, in each of which switching elements such as N-channel MOSFETs Q1 to Q4 are connected in an H-bridge form, respectively to both sides of a transformer 11 being an isolated unit. In other words, the power supply unit 8 is a DAB (Double Active Bridge) converter. Note that, the left-hand side of FIG. 1 is a vehicle side, and hence may sometimes be referred to as a V-side, and the right-hand side of FIG. 1 is a side where the grid power line 2 is present, and hence may sometimes be referred to as a P-side. In addition, unless it is necessary to make specific distinctions between the V-side and the P-side, corresponding suffixes V and P are not added to the reference symbols.

A common connection point between the FETs Q1V and Q3V of the full-bridge circuit 12V is connected to one end of a V-side coil of the transformer 11 via a coil 13V. Meanwhile, a common connection point between the FETs Q2V and Q4V is connected to another end of the V-side coil of the transformer 11 via a capacitor 14V. A common connection point between the FETs Q2P and Q4P of the full-bridge circuit 12P is connected to one end of a P-side coil of the transformer 11 via a capacitor 14P. Meanwhile, a common connection point between the FETs Q1P and Q3P is connected to another end of the P-side coil of the transformer 11 via a coil 13P.

A smoothing capacitor 15 is connected in parallel to the full-bridge circuit 12. A series circuit formed of an FET Q5 and an FET Q6 is connected in parallel to the smoothing capacitor 15V. A common connection point between the FETs Q5 and Q6 is connected to a positive terminal of the rechargeable battery 4 via an inductor 16. The FETs Q5 and Q6 and the inductor 16 are components of a step-up/down chopper 25. The transformer 11 and the full-bridge circuits 12V and 12P are components of a DAB converter 26. The power supply unit 8 includes the step-up/down chopper 25 and the DAB converter 26.

A DC output terminal of the DC/DC conversion circuit 6 is connected to a DC input-output terminal at the side toward power supply unit 8 of the AC/DC conversion circuit 5 and to a voltage measurement unit 18 via an ammeter 17 of the control unit 9. Results of measurement by the ammeter 17 are acquired by the current measurement unit 19. The voltage measurement unit 18 measures voltage at the smoothing capacitor 15 (in other words at the DC output terminal of the DC/DC conversion circuit 6), and the current measurement unit 19 measures current that flows from the DC output terminal of the DC/DC conversion circuit 6.

Output terminals of the voltage measurement unit 18 and the current measurement unit 19 are connected to input terminals of a power calculation unit 20. The power calculation unit 20 calculates power to be output from the DC/DC conversion circuit 6. Results of the calculation by the power calculation unit 20 are input to an operating-mode determination unit 21. The operating-mode determination unit 21 determines, on a basis of the calculation results to be input (such as power values), in which of operating modes the power supply unit 8 operates. Results of the determination by the operating-mode determination unit 21 are input to a power-supply control unit 22. In accordance with the determination results to be input (such as the operating modes), the power-supply control unit 22 controls switching operations of the FETs Q1 to Q6 in the power supply unit 8. Note that, hereinbelow, voltage at the smoothing capacitor 15 (in other words at the DC output terminal of the DC/DC conversion circuit 6) may sometimes be referred to as bus voltage.

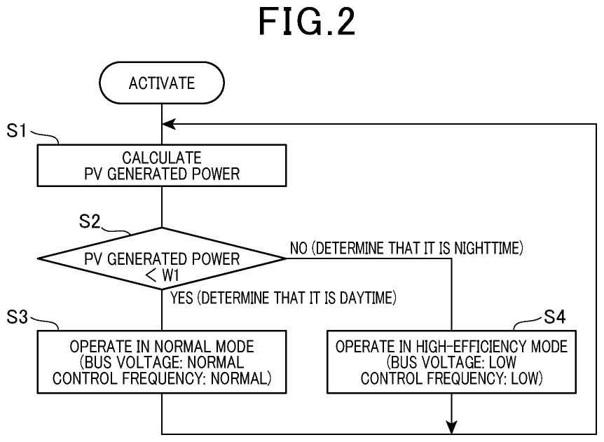

Next, functions of this embodiment are described. As shown in FIG. 2, in response to the calculation by the power calculation unit 20 of power generated by the solar panel 3 (S1), the control unit 9 compares the calculated generated power to a threshold W1 (S2). Note that, the prefix PV (Photovoltaic) in the flowchart refers to the solar panel. The threshold W1 is set, for example, to approximately 10 W.

Then, if the generated power has exceeded the threshold W1 (Yes), the control unit 9 determines that it is daytime in a time zone, and hence causes the power supply unit 8 to operate in a normal mode (S3). In other words, the bus voltage and a switching frequency of the power supply unit 8 are each set to a normal value. For example, the bus voltage is set to 380 V, and the switching frequency is set to 200 kHz.

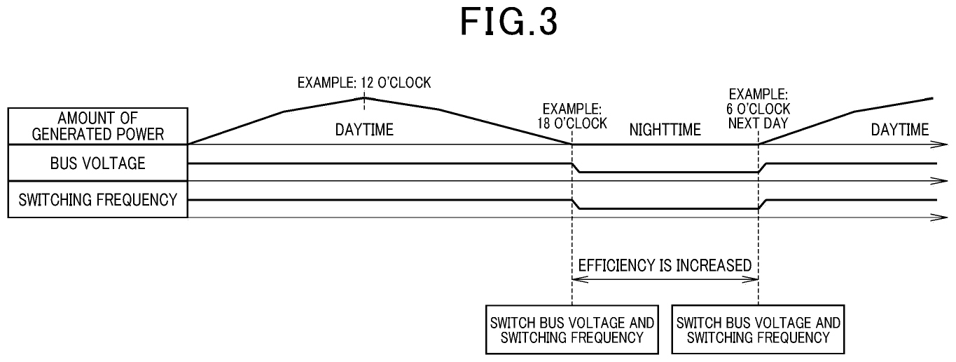

Meanwhile, if the generated power has not exceeded the threshold W1 (No), the control unit 9 determines that it is nighttime in the time zone, and hence causes the power supply unit 8 to operate in a high-efficiency mode (S4). In other words, the bus voltage and the switching frequency of the power supply unit 8 are each reduced to be smaller than the values in the normal mode. For example, the bus voltage is set to 340 V, and the switching frequency is set to 180 kHz. FIG. 3 is a timing chart showing an example of how an amount of the generated power varies over time, and how the bus voltage and the switching frequency vary in accordance with processes by the control unit 9.

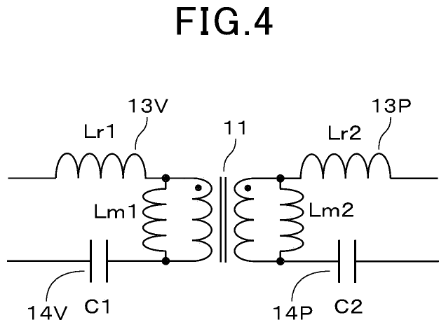

Next, a condition for restricting the switching frequency to be reduced in the high-efficiency mode is described. FIG. 4 is a diagram showing equivalent circuits that include resonant circuits and are arranged on both the sides of the transformer 11. Inductance of the coil 13V is denoted by Lr1, inductance of the V-side coil of the transformer 11 is denoted by Lm1, and capacitance of the capacitor 14V is denoted by C1. Inductance of the coil 13P is denoted by Lr2, inductance of the P-side coil of the transformer 11 is denoted by Lm2, and capacitance of the capacitor 14P is denoted by C2.

When the switching frequency is denoted by f, the control unit 9 controls the power supply unit 8 so that a switching frequency fd at a time of discharging the rechargeable battery 4 is within the following resonant frequency range in the normal mode.

1/{2π×(Lr1+Lm1)×C1}<fd<1/(2π×Lr1×C1)

Meanwhile, in the high-efficiency mode, when a switching frequency that is calculated on the basis of the reduced bus voltage is denoted by fd2, the control unit 9 compares this switching frequency fd2 and a frequency (1/{2π×(Lr1+Lm1)×C1}) to each other, and selects a higher one of these frequencies.

In addition, the control unit 9 controls the power supply unit 8 so that a switching frequency fc at a time of charging the rechargeable battery 4 is within the following range in the normal mode.

1/{2π×(Lr2+Lm2)×C2}<fc<1/(2π×Lr2×C2)

Meanwhile, in the high-efficiency mode, when a switching frequency that is calculated on the basis of the reduced bus voltage is denoted by fc2, the control unit 9 compares this switching frequency fc2 and a frequency (1/{2π×(Lr2+Lm2)×C2}) to each other, and selects a higher one of these frequencies.

As described above, according to this embodiment, the power supply unit 8 of the power conversion apparatus 7 is arranged between the rechargeable battery 4 and the set of the AC/DC conversion circuit 5 and the DC/DC conversion circuit 6, is connected to the AC/DC conversion circuit 5, the DC/DC conversion circuit 6, and the rechargeable battery 4, and bidirectionally converts voltage of DC power supplied from a connection destination. The AC/DC conversion circuit 5 converts AC power supplied from the grid power line 2 to DC power. The DC/DC conversion circuit 6 converts the voltage of the DC power supplied from the solar panel 3, and supplies this voltage-converted DC power to the DC output terminal of the AC/DC conversion circuit 5. The control unit 9 of the power conversion apparatus 7 causes the power supply unit 8 to vary the bus voltage at the DC output terminal in accordance with the power to be generated by the solar panel 3.

When the power controllers of the photovoltaic power-generation panels and the charger/discharger are integrated with each other as in the related art, the DC bus voltage needs to be adjusted to the voltage of the power supplied from the power controllers. However, in many cases, the voltage of the charger/discharger is lower than the voltage of the power supplied from the power controllers. For example, in many cases, voltage of power supplied by the photovoltaic power-generation panels exceeds 400 V, and in many cases, the voltage of the battery installed in a vehicle is less than 400 V. Thus, loss occurs in step-down conversion at a time of charging the battery, resulting in the decrease in power conversion efficiency. In particular, as a voltage difference becomes larger, an amount of the step-down at the time of the charging becomes larger, and the loss to occur in the step-down conversion becomes greater, with the result that an amount of the decrease in power conversion efficiency also becomes larger.

Meanwhile, the power generated by the solar panel 3 varies. The power generated by the solar panel 3 varies, for example, from time to time.

In accordance therewith, the power conversion apparatus 7 according to this embodiment varies the bus voltage in the power supply unit 8 in accordance with the power generated by the solar panel 3. In this way, in the power conversion apparatus 7, a power controller for the solar panel 3 and a charger/discharger for the rechargeable battery 4 can be integrated with each other, and the decrease in power conversion efficiency can be suppressed. The decrease in power conversion efficiency can be suppressed, for example, at the times of charging the rechargeable battery 4 and discharging the rechargeable battery 4.

Further, in response to that the power generated by the solar panel 3 is lower than the threshold W1, the control unit 9 causes the power supply unit 8 to reduce the bus voltage. By reducing a difference in potential between before and after the conversion in the power supply unit 8 in response to the decrease in power supplied from the solar panel 3 in this way, the decrease in power conversion efficiency can be suppressed.

Still further, the power supply unit 8 includes the switching elements that perform the switching operations. In response to that the power generated by the solar panel 3 is lower than the threshold W1, the control unit 9 causes the power supply unit 8 to reduce the switching frequencies used in the switching operations. With this, switching loss to occur in the power supply unit 8 can be reduced, and hence an advantage of suppressing the decrease in power conversion efficiency can be further enhanced.

Yet further, the power supply unit 8 is a resonant converter. The control unit 9 compares a switching frequency f1 calculated on the basis of the reduced bus voltage and a resonant frequency f2 of the power supply unit 8 to each other, and selects a higher one of the calculated switching frequency f1 and the resonant frequency f2 as the switching frequency f used in the switching operations. With this, shortening of lives of circuit devices due to an excessive decrease in switching frequency f can be avoided.

### Second Embodiment

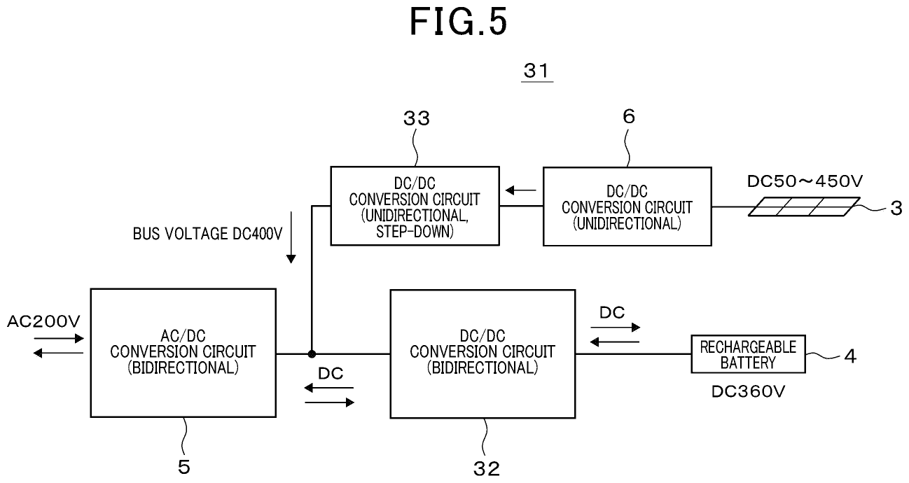

Now, the same parts as those according to the first embodiment are denoted by the same reference symbols to omit redundant description, and differences from the first embodiment are described. In a V2H system 31 according to a second embodiment of the present disclosure shown in FIG. 5, a DC/DC conversion circuit 32 corresponds to the power conversion apparatus 7 according to the first embodiment. This DC/DC conversion circuit 32 does not execute the processes shown in FIG. 2, and operates always in the normal mode. In the second embodiment, another DC/DC conversion circuit 33 (a third converter) is added between the AC/DC conversion circuit 5 and the DC/DC conversion circuit 6. The DC/DC conversion circuit 33 performs a step-down operation with unidirectional conversion.

With such a configuration, even when operating modes of the DC/DC conversion circuit 32 cannot be switched unlike the first embodiment, the bus voltage is always reduced by the DC/DC conversion circuit 33. With this, the decrease in power conversion efficiency can be suppressed.

In addition, the DC/DC conversion circuit 33 always performs step-down to given target voltage. With this, the operating modes in the power supply unit 8 need not be switched (in other words, the bus voltage need not be varied). As a result, a configuration of the power supply unit 8 can be simplified. Note that, the DC/DC conversion unit 33 may be a non-isolated converter. In this case, the power conversion efficiency of the DC conversion unit 33 can be higher than one in case that the DC/DC conversion unit 33 is an isolated converter. In addition, the DC/DC conversion unit 33 may reduce the bus voltage in response to the determination that it is nighttime.

The present disclosure is not limited only to the above-described embodiments, and may be modified or expanded as follows.

The switching devices need not necessarily be the N-channel MOSFETs, and may be IGBTs (Insulated Gate Bipolar Transistors) or SiC semiconductors or GaN semiconductors.

The bus voltage, the switching frequencies, and the threshold at the time when the operating mode is switched may be freely set as appropriate in accordance with individual design.

The power supply unit 8 may be a LLC converter.

What is claimed is:

1. A power conversion apparatus comprising:
an isolated converter
that is arranged between a rechargeable battery and a set of a first converter and a second converter,
that is connected to the first converter, the second converter, and the rechargeable battery, and
that is configured to bidirectionally convert voltage of direct-current power supplied from a connection destination; and
a control unit that is configured to cause the isolated converter to vary voltage at a direct-current input-output terminal of the first converter in accordance with power generated by a photovoltaic power generator, the direct-current input-output terminal being connected to the isolated converter, wherein
the first converter is configured to convert alternating-current power supplied from a grid power line to direct-current power,
the second converter is configured
to convert voltage of direct-current power supplied from the photovoltaic power generator, and
to supply the voltage-converted direct-current power to the direct-current input-output terminal of the first converter.

2. The power conversion apparatus according to claim 1,
wherein, in response to the power generated by the photovoltaic power generator being lower than a threshold, the control unit is configured to cause the isolated converter to reduce the voltage at the direct-current input-output terminal of the first converter.

3. The power conversion apparatus according to claim 2,
wherein the isolated converter includes a switching element that performs a switching operation, and
wherein, in response to the power generated by the photovoltaic power generator being lower than the threshold, the control unit is configured to cause the isolated converter to reduce a switching frequency used in the switching operation.

4. The power conversion apparatus according to claim 3,
wherein the isolated converter is a resonant converter, and
wherein the control unit is configured
to compare the switching frequency calculated on a basis of the reduced voltage at the direct-current input-output terminal of the first converter and a resonant frequency of the isolated converter, and
to select a higher one of the calculated switching frequency and the resonant frequency as the switching frequency used in the switching operation.

5. A power conversion apparatus comprising:
an isolated converter
that is arranged between a rechargeable battery and a set of a first converter and a second converter,
that is connected to the first converter, the second converter, and the rechargeable battery, and
that is configured to bidirectionally convert voltage of direct-current power supplied from a connection destination; and
a third converter
that is arranged between the second converter and the isolated converter, and
that is configured
to convert voltage of direct-current power supplied from the second converter to given voltage, and
to supply the voltage-converted direct-current power to a direct-current input-output terminal of the first converter, wherein
the first converter is configured to convert alternating-current power supplied from a grid power line to direct-current power,
the second converter is configured to convert voltage of direct-current power supplied from the photovoltaic power generator.

6. The power conversion apparatus according to claim 1,
wherein the isolated converter is a DAB (Double Active Bridge) converter or a LLC converter.
